(19) United States
(12) Patent Application Publication
(10) Pub. No.: US 2022/0316848 A1
(43) Pub. Date: Oct. 6, 2022

(54) TACTICAL REMOTE WIRE CUTTING SYSTEM AND ASSOCIATED METHODS

(71) Applicant: Haden Pyatt, Three Forks, MT (US)

(72) Inventor: Haden Pyatt, Three Forks, MT (US)

(21) Appl. No.: 17/658,116

(22) Filed: Apr. 6, 2022

Related U.S. Application Data
(60) Provisional application No. 63/171,307, filed on Apr. 6, 2021.

(51) Int. Cl. F42B 33/06; B21F 11/00

(52) U.S. Cl. CPC F42B 33/06; B21F 11/00

(57) ABSTRACT

The untethered remote wire cutting system includes a control unit with a unit housing carrying a user input interface coupled to control circuitry, a unit battery, an associated control transceiver, and a unit antenna, and configured to transmit wireless cutting control signals. One or more wire cutting devices each include a device housing carrying device circuitry, a device battery, an associated device transceiver, and a device antenna, and configured to receive wireless cutting control signals from the control unit. The wire cutting device includes a blade guide, having wire retaining slots, and coupled to the device housing. Also, a blade is configured for linear movement within the blade guide, and a linear actuator is carried within the device housing, coupled to the blade, and controlled by the device circuitry to move the blade linearly within the blade guide and passed the wire retaining slots.

### FIELD

The present invention relates in general to the field of explosive ordnance disposal (EOD), and particularly to wire cutting systems, devices and procedures during EOD.

### BACKGROUND

Military operations in combat theaters around the world often expose the warfighter to hazards that require specialized tactics, techniques and equipment to defeat. Improvised explosive devices (LEDs), one of the most dangerous threats facing warfighters today, demands cutting edge technology to render them safe for disposal.

There are various technologies that have been developed or adopted to disarm or render safe LEDs. Current mitigation equipment is focused on allowing specially trained EOD technicians to disarm explosive devices using remote approaches, often through robotic platforms.

While these technologies may provide the warfighter with a broad spectrum of approaches to defeat the growing IED threat, a critical need remains. EOD technicians across all branches of the military and law enforcement have a need to perform all wire cutting procedures remotely. Materials subject to cutting procedures include electric wires, cables, corded explosives and rope.

Currently, however, there are no lightweight, man-portable systems or devices that allow for the swift placement and execution of cutting operations. Cutting capabilities are currently limited to hand tools, which primarily involve the use of various safety belt cutting tools, often referred to as “j hooks”. The procedure currently used to employ manual cutting hooks is to connect the cutting tool to a rope, place the cutting edge of the hook over the item that requires cutting, and then manually pull the cutting hook, via the rope, from a safe distance.

This current method is ineffective for a number of reasons. First, it requires multiple steps that waste valuable time. Second, it requires the technician to spend time in close proximity to the suspected threat as they place the hook on the item that requires cutting. Third, debris-filled environments can, and do, either fray or cut the rope attached to the hook as the rope is pulled. Finally, after a cutting operation by this method has been executed, a technician is required to re-enter the hazardous area to verify whether or not the attempt was successful.

Exploiting or disarming IEDs is a dynamic, high-threat mission with a necessity for remote equipment that is absolute. The currently unmet need for the use of remote technology risks the lives of the technicians tasked with defeating this threat and, by extension, those troops whose lives depend on the success of those technicians. The current lack of remote, untethered, and reliable cutting technology is a deficiency that increases the potential for mission failure and, by extension, continued loss of life.

So, as discussed, current wire cutting procedures are done manually by operators or by utilizing rescue hook blades attached to a rope, and no true remote and lightweight portable platforms exist to alleviate this deficiency.

This background information is provided to reveal information believed by the applicant to be of possible relevance to the present invention. No admission is intended, nor should be construed, that any of the preceding information constitutes prior art against the present invention.

### SUMMARY OF THE INVENTION

With the above in mind, embodiments of the present invention are related to a tactical and untethered remote wire cutting capability that protects technicians and increases mission success.

This and other objects, advantages and features in accordance with the present invention may be provided by an untethered remote wire cutting system including a control unit with a unit housing carrying a user input interface coupled to control circuitry, a unit battery, an associated control transceiver, and a unit antenna, and configured to transmit wireless cutting control signals. One or more wire cutting devices each include a device housing carrying device circuitry, a device battery, an associated device transceiver, and a device antenna, and configured to receive wireless cutting control signals from the control unit. The wire cutting device includes a blade guide, having wire retaining slots, and coupled to the device housing. Also, a blade is configured for linear movement within the blade guide, and a linear actuator is carried within the device housing, coupled to the blade, and controlled by the device circuitry to move the blade linearly within the blade guide and passed the wire retaining slots.

Additionally and/or alternatively, the user input interface of the control unit includes a display and associated push buttons.

Additionally and/or alternatively, the unit housing is a ruggedized unit housing, and the device housing is a ruggedized device housing.

Additionally and/or alternatively, the wire cutting device includes a blade harness coupling the blade to the linear actuator. The blade is selected blade from a plurality of types of blades.

Additionally and/or alternatively, the linear actuator is an electromechanical motor that provides a linear force in the range of 40-64 lbs.

Additionally and/or alternatively, the control unit transmits the wireless cutting control signals as assigned encrypted commands for extension, retraction, and positional control of the linear actuator. The assigned encrypted commands may be transmitted as Radio Control (RC) packets at 900 MHz for long range use in the range of 5-10 Km.

Additionally and/or alternatively, a plurality of wire cutting devices are each configured to receive wireless cutting control signals from the control unit to perform multiple cuts simultaneously.

Another embodiment is directed to an untethered remote wire cutting device configured to receive wireless cutting control signals. The wire cutting device includes a device housing carrying device circuitry, a device battery, an associated device transceiver, and a device antenna, and is configured to receive the wireless cutting control signals. A blade guide, having wire retaining slots, is coupled to the device housing. A blade is configured for linear movement within the blade guide. A linear actuator is carried within the device housing, coupled to the blade, and controlled by the device circuitry to move the blade linearly within the blade guide and passed the wire retaining slots.

Additionally and/or alternatively, the device housing is a ruggedized device housing.

Additionally and/or alternatively, the wire cutting device includes a blade harness coupling the blade to the linear actuator, and the blade is selected blade from a plurality of types of blades.

Additionally and/or alternatively, the linear actuator comprises an electromechanical motor that provides a linear force in the range of 40-64 lbs.

Additionally and/or alternatively, the wireless cutting control signals are received as assigned encrypted commands for extension, retraction, and positional control of the linear actuator. The assigned encrypted commands may be received as Radio Control (RC) packets at 900 MHz for long range use in the range of 5-10 Km.

Another embodiment is directed to a method of untethered remote wire cutting. The method includes: providing a control unit including a unit housing carrying a user input interface coupled to control circuitry, a unit battery, an associated control transceiver, and a unit antenna, to transmit wireless cutting control signals; and providing a wire cutting device including a device housing carrying device circuitry, a device battery, an associated device transceiver, and a device antenna, to receive wireless cutting control signals from the control unit. The wire cutting device includes a blade guide, having wire retaining slots, and coupled to the device housing. A blade for linear movement is within the blade guide, and a linear actuator is carried within the device housing, coupled to the blade, and controlled by the device circuitry to move the blade linearly within the blade guide and passed the wire retaining slots. The method further includes: positioning the wire cutting device adjacent a wire to be cut and with the wire located with one of the wire retaining slots; and remotely operating the control unit to transmit wireless cutting control signals to the wire cutting device positioned adjacent the wire to operate the linear actuator to move the blade and cut the wire.

Additionally and/or alternatively, the linear actuator comprises an electromechanical motor that provides a linear force in the range of 40-64 lbs.

Additionally and/or alternatively, the control unit transmits the wireless cutting control signals as assigned encrypted commands for extension, retraction, and positional control of the linear actuator. The assigned encrypted commands may be transmitted as Radio Control (RC) packets at 900 MHz for long range use in the range of 5-10 Km.

### BRIEF DESCRIPTION OF THE DRAWINGS

The example embodiments are best understood from the following detailed description when read with the accompanying drawing figures. In fact, the dimensions may be arbitrarily increased or decreased for clarity of discussion. Wherever applicable and practical, like reference numerals refer to like elements.

FIG. 1 is a schematic perspective view illustrating an example embodiment of a Tactical Remote Wire Cutting System including a control unit and wire cutting device in accordance with features of the present invention.

FIGS. 2A-2D are a various view illustrating details of the control unit of the Tactical Remote Cutting System of FIG. 1.

FIGS. 3A-3H are various views illustrating details of the wire cutting device of the Tactical Remote Cutting System of FIG. 1.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

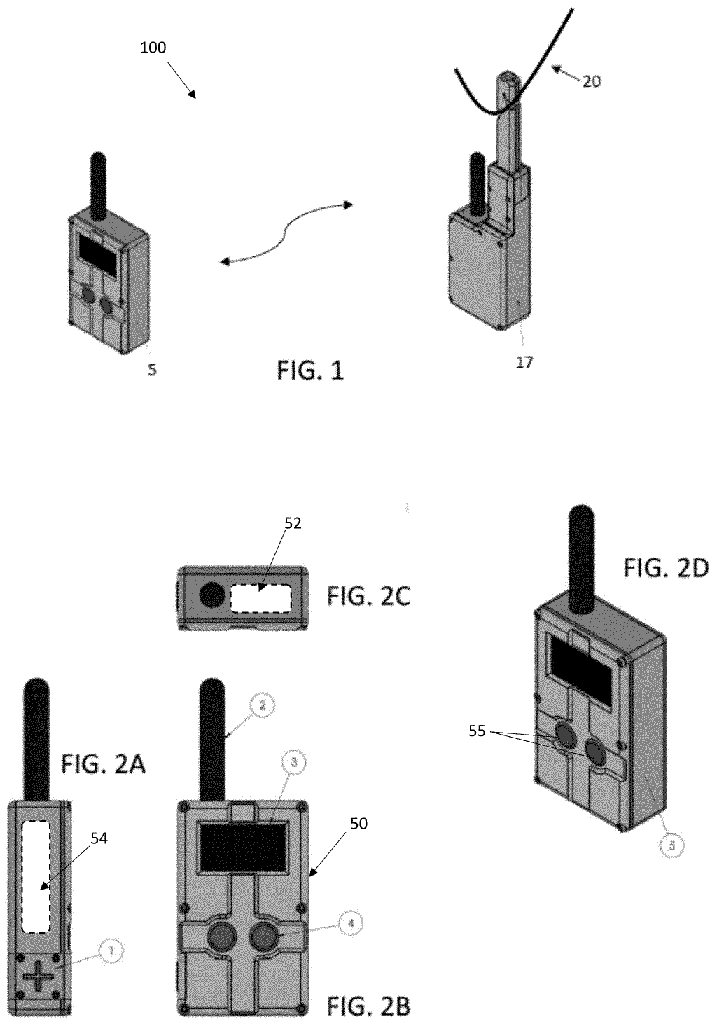

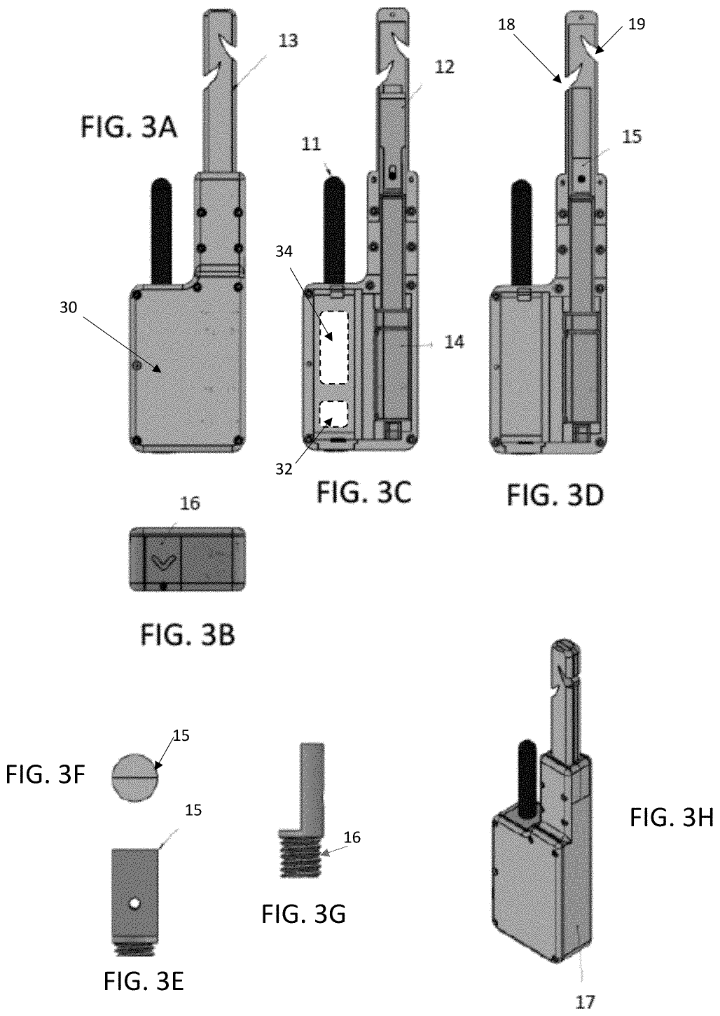

FIG. 1 illustrates an example embodiment of a tactical remote cutting system 100 including a transmitter or control unit 5 and a receiver or wire cutting device 17 that are coupled together via a wireless communication channel. FIGS. 2A-2D are a various views illustrating details of the control unit 5, and FIGS. 3A-3H are various views illustrating details of the wire cutting device 17.

The two part system 100 (transmitter and receiver) may communicate, for example, via encrypted RC packets which allows for untethered remote control of a wire cutting process. As an example, the RC signal may utilize 900 MHz, LoRa, which supports long range use in the range of 5-10 Km. Of course, other wireless communication approaches are contemplated. Furthermore. More than one wire cutting device 17 may be controlled by a single control unit 5 to thereby provide for multiple wire cutting capabilities simultaneously.

Referring to FIGS. 2A-2D, the control unit 5 may be a ruggedized portable handheld device that includes a housing 50 and battery 52 within a battery compartment 1. The shape and features of the housing 50 is an example as illustrated, and other shapes and features are contemplated. An antenna 2 may be flexible and may be external or internal of the housing 50. A display screen 3 (e.g. an LCD screen) may be included on the housing 50 and coupled to internal circuitry 54 to display settings, power, parameters and any other information desired by the technician. A user interface 4, such as control push buttons 55 may also be included, and coupled to the internal circuitry 54, to control various operations of the tactical remote cutting system 100. The user interface may also be a touch screen display as would be appreciated by those skilled in the art.

Referring to FIGS. 3A-3H, the wire cutting device 17 may be a ruggedized portable positionable device that includes a housing 30 and battery 32 within a battery compartment 16. The shape and features of the housing 30 is an example as illustrated, and other shapes and features are contemplated. An antenna 11 may be flexible and may be external or internal of the housing 30. The wire cutting device 17 may include a linear actuator, such as an electromechanical motor 14, that provides linear force (e.g., in the range of 40-64 lbs). A blade 12, for example, is retained by a blade harness 15 that is connected to the motor 14. The blade harness 15 couples the blade 12 to the linear actuator 14. The blade harness 15 may include a threaded stem 16 to couple to the linear actuator 14.

Various blades may be selected from a plurality of different types of blades, such as chisel blades, beveled or curved, for example. This blade 12 is driven through a cutting assembly or blade guide 13 that includes one or more wire retaining slots 18 and 19 therein. Of course, although two wire retaining slots are illustrated, there may be more or less wire retaining slots 18/19 as desired.

Various computer hardware, software and firmware may be included within each component as would be appreciated by those skilled in the art. An example of the computer or processor logic will be described below.

Each of the control unit 5 and the wire cutter device 17 may contain circuitry (e.g. on a printed circuit board) including a computer chip, or logic, that utilizes a microcontroller, memories, and a radio or wireless transceiver to operate. The logic in the two devices may not need to be paired for use.

The logic circuitry 34 or 54 may be referred to as an integrated circuit chip or processor which may be implemented in hardware, firmware, or a combination of hardware and software. Such a processor may include a processor (e.g., a central processing unit (CPU), a graphics processing unit (GPU), an accelerated processing unit (APU), etc.), a microprocessor, and/or any processing component (e.g., a field-programmable gate array (FPGA), an application-specific integrated circuit (ASIC), etc.) that interprets and/or executes instructions. In some implementations, the processor may include one or more processors capable of being programmed to perform a function. An associated memory may include a random access memory (RAM), a read only memory (ROM), and/or another type of dynamic or static storage device (e.g., a flash memory, a magnetic memory, an optical memory, etc.) that stores information and/or instructions for use by the processor.

Communication interface may include a transceiver-like component (e.g., a transceiver, a separate receiver and transmitter, etc.) that enables the control unit 5 or cutting device 17 to communicate with other devices, such as via a wired connection, a wireless connection, or a combination of wired and wireless connections. Communication interface may permit devices to receive information from another device and/or provide information to another device. For example, communication interface may include an Ethernet interface, an optical interface, a coaxial interface, an infrared interface, a radio frequency (RF) interface, a universal serial bus (USB) interface, a Wi-Fi interface, a cellular network interface, or the like.

The components may perform one or more processes described herein. Device 17 may perform these processes in response to control unit 5 executing software instructions stored by a non-transitory computer-readable medium. A computer-readable medium is defined herein as a non-transitory memory device. A memory includes memory space within a single physical storage device or memory space spread across multiple physical storage devices.

Software instructions may be read into a memory from another computer-readable medium or from another device via communication interface. When executed, software instructions may cause control unit 5 or processor to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIGS. 1-3 are provided as an example. In practice, system 100 may include additional components, fewer components, different components, or differently arranged components than those shown in FIGS. 1-3. Additionally, or alternatively, a set of components (e.g., one or more components) of system 100 may perform one or more functions described as being performed by another set of components of system 100.

The circuitry 54 in the control unit 5 may be programmed to send small encrypted commands or “data packets”, only upon activation by the user. The wire cutting device 17, conversely, may always be searching or ready for a command. Extension, retraction, and positional control of the linear actuator 14 may all be controlled by assigned encrypted commands. This form of communication between the two components is a reliable method that enables the user to quickly place the wire cutting device 17 without a requirement to pair it with the control unit 5.

In the control unit 5, the logic circuitry 54 drives the display screen 3, manages battery life, and manages the wireless communication. The logic circuitry 54 ultimately controls the transmission of commands for the wire cutting device 17 in the form of small encrypted data packets. The frequencies may be user configurable for flexibility and integration with existing military or commercial RC control platforms. The range of frequencies available for use enables control via existing mesh network communication platforms as well. The logic circuitry 54 may drive a navigational menu that may be displayed on the display 3. This menu, and associated control buttons 55 or touch screen, may control all transmission functions of the control unit 5.

In the wire cutter, the logic circuitry 34 drives the radio, manages the battery 32, and controls the linear actuator 14 when commands have been received. When a recognized command is received, the linear actuator 14 will perform a specific pre-designated function. Upon completion of the function, the logic circuitry 34 may then send a reply transmission to the control unit 5. This reply transmission communicates to the user whether the function (wire cut) was successful and the current state of the linear actuator 14 via positional feedback.

In use, the EOD technician will position the wire cutting device 17 adjacent one or more wires (e.g., the wire 20) that need to be cut. The wire 20 will be guided into a cutting slot 18/19 on the blade guide 13. The technician, with the handheld control unit 5, will then proceed to move away from the location of the Receiver (Wire Cutting Device) 17 to an appropriate distance as would be appreciated by those skilled in the field of EOD. The technician will activate the Receiver (Wire Cutting Device) 17 using the Transmitter (Control Unit) 5 to cut the wire 20 and disarm the explosive.

The invention provides an untethered remote cutting capability in a lightweight package which allows for use by dismounted operators that need to maintain an ultralight equipment loadout.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related items, and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As may be used herein, the terms “substantially” and “approximately” provides an industry-accepted tolerance for its corresponding term and/or relativity between items. Such an industry-accepted tolerance ranges from less than one percent to fifty percent. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module). As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship.

As may also be used herein, the terms “processor”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The above description provides specific details, such as material types and processing conditions to provide a thorough description of example embodiments. However, a person of ordinary skill in the art would understand that the embodiments may be practiced without using these specific details.

Some of the illustrative aspects of the present invention may be advantageous in solving the problems herein described and other problems not discussed which are discoverable by a skilled artisan. While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item. Thus, the scope of the invention should be determined by the appended claims and their legal equivalents, and not by the examples given.

1. An untethered remote wire cutting system comprising:
a control unit including a unit housing carrying a user input interface coupled to control circuitry, a unit battery, an associated control transceiver, and a unit antenna, and configured to transmit wireless cutting control signals; and
at least one wire cutting device including a device housing carrying device circuitry, a device battery, an associated device transceiver, and a device antenna, and configured to receive wireless cutting control signals from the control unit;
the at least one wire cutting device comprising
a blade guide, having wire retaining slots, and coupled to the device housing,
a blade configured for linear movement within the blade guide,
a linear actuator carried within the device housing, coupled to the blade, and controlled by the device circuitry to move the blade linearly within the blade guide and passed the wire retaining slots.

2. The untethered remote wire cutting system according to claim 1, wherein the user input interface of the control unit comprises a display and associated push buttons.

3. The untethered remote wire cutting system according to claim 1, wherein the unit housing comprises a ruggedized unit housing, and the device housing comprises a ruggedized device housing.

4. The untethered remote wire cutting system according to claim 1, wherein the wire cutting device comprises a blade harness coupling the blade to the linear actuator.

5. The untethered remote wire cutting system according to claim 1, wherein the blade comprises a selected blade from a plurality of types of blades.

6. The untethered remote wire cutting system according to claim 1, wherein the linear actuator comprises an electromechanical motor that provides a linear force in the range of 40-64 lbs.

7. The untethered remote wire cutting system according to claim 1, wherein the control unit transmits the wireless cutting control signals as assigned encrypted commands for extension, retraction, and positional control of the linear actuator.

8. The untethered remote wire cutting system according to claim 7, wherein the assigned encrypted commands are transmitted as Radio Control (RC) packets at 900 MHz for long range use in the range of 5-10 Km.

9. The untethered remote wire cutting system according to claim 1, wherein the at least one wire cutting device includes a plurality of wire cutting devices each configured to receive wireless cutting control signals from the control unit to perform multiple cuts simultaneously.

10. An untethered remote wire cutting device configured to receive wireless cutting control signals, the device comprising:
a device housing carrying device circuitry, a device battery, an associated device transceiver, and a device antenna, and configured to receive the wireless cutting control signals;
a blade guide, having wire retaining slots, and coupled to the device housing;
a blade configured for linear movement within the blade guide; and
a linear actuator carried within the device housing, coupled to the blade, and controlled by the device circuitry to move the blade linearly within the blade guide and passed the wire retaining slots.

11. The untethered remote wire cutting device according to claim 10, wherein the device housing comprises a ruggedized device housing.

12. The untethered remote wire cutting device according to claim 10, wherein the wire cutting device comprises a blade harness coupling the blade to the linear actuator.

13. The untethered remote wire cutting device according to claim 12, wherein the blade comprises a selected blade from a plurality of types of blades.

14. The untethered remote wire cutting device according to claim 10, wherein the linear actuator comprises an electromechanical motor that provides a linear force in the range of 40-64 lbs.

15. The untethered remote wire cutting device according to claim 10, wherein the wireless cutting control signals are received as assigned encrypted commands for extension, retraction, and positional control of the linear actuator.

16. The untethered remote wire cutting device according to claim 15, wherein the assigned encrypted commands are received as Radio Control (RC) packets at 900 MHz for long range use in the range of 5-10 Km.

17. A method of untethered remote wire cutting comprising:
providing a control unit including a unit housing carrying a user input interface coupled to control circuitry, a unit battery, an associated control transceiver, and a unit antenna, to transmit wireless cutting control signals;
providing a wire cutting device including a device housing carrying device circuitry, a device battery, an associated device transceiver, and a device antenna, to receive wireless cutting control signals from the control unit;
the at least one wire cutting device comprising
a blade guide, having wire retaining slots, and coupled to the device housing,
a blade for linear movement within the blade guide,
a linear actuator carried within the device housing, coupled to the blade, and controlled by the device circuitry to move the blade linearly within the blade guide and passed the wire retaining slots;
positioning the wire cutting device adjacent a wire to be cut and with the wire located with one of the wire retaining slots; and
remotely operating the control unit to transmit wireless cutting control signals to the wire cutting device positioned adjacent the wire to operate the linear actuator to move the blade and cut the wire.

18. The untethered remote wire cutting method according to claim 17, wherein the linear actuator comprises an electromechanical motor that provides a linear force in the range of 40-64 lbs.

19. The untethered remote wire cutting method according to claim 17, wherein the control unit transmits the wireless cutting control signals as assigned encrypted commands for extension, retraction, and positional control of the linear actuator.

20. The untethered remote wire cutting method according to claim 19, wherein the assigned encrypted commands are transmitted as Radio Control (RC) packets at 900 MHz for long range use in the range of 5-10 Km.
